(19) United States
(12) Patent Application Publication
(10) Pub. No.: US 2009/0143537 A1
(43) Pub. Date: Jun. 4, 2009

(54) Melt-polymerization surface reinforcement and hardening of wood, wood products and other porous materials using oligimer and polymer solutes in polymerizable monomer solvent

(76) Inventors: Marc Henry Schneider, Fredericton (CA); Jonathan Greer Phillips, Fredericton (CA)

Correspondence Address: Ralph A. Dowell of DOWELL & DOWELL P.C., 2111 Eisenhower Ave, Suite 406, Alexandria, VA, 22314, US

(21) Appl. No.: 11/987,414

(22) Filed: Nov. 29, 2007

(51) Int. Cl. C08F 279/00; C08H 5/02

(52) U.S. Cl. 525/242; 527/400

(57) ABSTRACT

This invention is a method preparing solutions or mixtures of oligimer or polymer in a solution of polymerizable monomer, applying that solution to the surface of a solid porous substance like wood, heating to drive the mixture into the surface zone of the substance and causing the polymerizable monomer to cure. This produces a reinforced, hardened, protective shell around the porous substance.

### FIELD OF THE INVENTION

The present invention relates to methods for melt-polymerization surface reinforcement and hardening of wood, wood products and other porous materials using oligimer and polymer solutes in polymerizable monomer solvent.

### BACKGROUND OF THE INVENTION

Wood surfaces are typically soft. They collect soil and are difficult to clean. They easily absorb water and other liquids. Outdoors, they are subject to breakdown by weathering. As a result, exposed surfaces of wood products are usually coated with a polymeric film of some type. Earlier films were made from natural resins and drying oils. More recent ones incorporate modern polymers. However, coatings are basically films of polymer sitting on, and usually well-attached to, the wood substrate. They do protect the surface from soiling and the effects of weather to a certain extent. And they do harden the surface slightly.

However, coating films have limited hardening and protecting capabilities simply because they are films. The films are typically thin and therefore on their own have little resistance to indentation. The wood below them reinforces the film, but the combination of wood and film is little harder than the wood alone. Even thick, hard films which are used on some flooring, have limited hardness and abrasion resistance. Because coatings are films attached to the surface, there is a boundary layer that can be susceptible to breakage, releasing the film from the surface. This is particularly evident when water causes paint blistering and detachment. Also, because the coating is a film, when the film is breached mechanically or by weathering, the wood beneath is left unprotected.

There have been many attempts made to overcome these shortcomings of coating films. The main approach has been to modify coatings formulations to improve their adhesion and resistance to deterioration. However, this approach has limitations because there are still two different substances, one on top of the other. Each of these substances has weaknesses that can only be improved a limited amount by the proximity of the other. To make a large improvement in properties, a true combination of substances at the surface is needed.

Therefore, a need exists for an efficient and economical method of applying protective coatings to porous surfaces such as wood products.

### SUMMARY OF THE INVENTION

The present invention provides methods for melt-polymerization surface reinforcement and hardening of wood, wood products and other porous materials using oligimer and polymer solutes in polymerizable monomer solvent.

In an embodiment of the present invention there is provided a method of method of melt-polymerization surface zone reinforcement and hardening of wood, wood products and other porous materials, comprising the steps of:

a) mixing liquid furfuryl alcohol with solid maleic anhydride wherein said maleic anhydride dissolves in said furfuryl alcohol;

b) adding lignin to the mixture of furfuryl alcohol with maleic anhydride to give a furfuryl alcohol-lignin mixture; and

c) applying the furfuryl alcohol-lignin mixture to a surface of a porous material wherein some of the furfuryl alcohol-lignin mixture is absorbed into the surface, and curing said furfuryl alcohol-lignin mixture.

In another embodiment of the present invention there is provided a method of melt-polymerization surface reinforcement and hardening of wood, wood products and other porous materials, comprising the steps of:

a) dissolving solid polystyrene in styrene monomer to form a first solution;

b) adding a polymerization initiator and adding a cross-linking agent to the first solution to form a second solution; and

c) applying said second solution to a surface of a porous material and curing the second solution after absorption into the surface.

### DETAILED DESCRIPTION OF THE INVENTION

The methods described herein are directed, in general, to melt-polymerization surface reinforcement and hardening of wood, wood products and other porous materials using oligimer and polymer solutes in a polymerizable monomer solvent. Although embodiments of the present invention are disclosed herein, the disclosed embodiments are merely exemplary.

Therefore, specific structural and functional details disclosed herein are not to be interpreted as limiting but merely as a basis for the claims and as a representative basis for enabling someone skilled in the art to employ the present invention in a variety of ways. For purposes of instruction and not limitation, the illustrated embodiments are all directed to embodiments of melt-polymerization surface reinforcement and hardening of wood, wood products and other porous materials using oligimer and polymer solutes in a polymerizable monomer solvent.

As used herein, the term “about”, when used in conjunction with ranges of concentrations of constituents of various formulations or other physical properties or characteristics, is meant to cover slight variations that may exist in the upper and lower limits of the ranges of concentrations so as to not exclude embodiments with concentrations slightly above or below those recited herein. It is not the intention to exclude embodiments such as these from the present invention.

The present inventors have discovered chemical formulations and a process that produces a hardened, biodeterioration-resistant and moisture-resistant shell on wood and wood product surfaces. This can be accomplished on the bare wood product or a surface laminate and can be applied at the same time. To do this, the chemical formulation should preferably be: a) able to be easily prepared by mixing ingredients; b) fluid enough to be spread on surfaces; c) able to penetrate a controlled amount into the substrate but also be present on and near the surface in sufficient concentration to give desired property increases; and d) able to be easily polymerized when in place inside the wood shell.

The process and formulation disclosed herein works on other soft, porous materials such as, but not limited to, paperboard and boards made with agricultural fibers like kenaf, corn and straw.

### Method

The present method uses two different chemical formulations:
1. Lignin dissolved in furfuryl alcohol. This makes a dark brown product.
2. Polystyrene dissolved in styrene. This is a clear formulation that can be dyed.
   These formulations may be combined, producing a light brown product.

### Furfuryl Alcohol-Lignin Surface Modifier

Furfuryl alcohol (FA) monomer is the solvent and also the polymerizable chemical constituent. Maleic anhydride (MA) is a solid which dissolves in furfuryl alcohol. The role of the maleic anhydride is to cause the mixture to polymerize by acting as a catalyst and probably a co-reactant. This dissolution is facilitated by having the maleic anhydride in a granular or briquette form. Granular maleic anhydride dissolves quickly in furfuryl alcohol and produces heat so dissolution is an auto-accelerating process.

An embodiment of the process includes:
1. adding about 20% (by weight) of maleic anhydride to the furfuryl alcohol at about 20° C.
2. After the maleic anhydride has dissolved, lignin is added at about 50% based on the weight of furfuryl alcohol.

While maleic anhydride at about 20% (by weight) is preferred, it may be present in a range from about 10% to about 30% by weight of maleic anhydride to the furfuryl alcohol at a temperature in a range from about 20° C. to about 40° C. Similarly, the lignin is added preferably at about 50% but it could be added in a range from about 20% to about 200% based on weight of furfuryl alcohol.

Organosolv lignin was used in development of this coating formulation because it dissolves well in furfuryl alcohol. Other types of lignin were tried and some dissolved in the furfuryl alcohol and others blended with furfuryl alcohol but did not appear to form a solution. Each type used, however, formed a useful, penetrating, polymerizable formulation. Water soluble lignins were also used and worked well. Basic lignin types that were used are lignosulfonates, lignosulfonic acids and kraft lignins.

Lignin fulfils several special functions in this formulation. It increases mix viscosity for better surface spreading, it causes substantial reduction in furfuryl alcohol monomer evaporation losses during curing and it prevents furfuryl alcohol from flowing deeply into the wood substrate during early stages of hot press curing. It contributes to the formation of thermoset polymer by reacting with the furfuryl alcohol and maleic anhydride.

Fiber mats (made of burlap, woven kenaf outer fiber, etc) can be saturated with the furfuryl alcohol-lignin mixture and partially cured for later use as prepregs in hot press applications. The partial cure is accomplished by allowing the saturated mat to sit at room temperature for 24 to 48 hours, or be heating to 30 C to 40 C for 3 to 4 hours.

### Styrene Monomer-Polymer Surface Modifier

In the past, the inventors have used several vinyl monomers to reinforce wood and wood products using a vacuum-pressure process. Styrene is particularly suitable for this purpose because it is the least expensive, polymerizes well and produces a useful wood-polymer composite. To test the applicability of such monomers as surface reinforcers, styrene monomer containing an initiator(s) and a cross-linker(s), in the same proportions as would be used for a vacuum-pressure process, were applied to a wooden board. The formulation penetrated deeply (5 to 7 mm) into the board used. Monomer near the surface evaporated and the polymer saturation in the penetrated zone was low. This was evident by hardness values just slightly higher than untreated wood in the treated zone.

Adding styrene polymer to the formulation reduced monomer evaporation to the atmosphere and restricted its mobility in the wood. This caused higher polymer loading in the penetrated zone than was achieved with styrene monomer alone and therefore enhanced properties in the surface zone.

In this formulation, styrene monomer was used as a polymerizable solvent. Solid polystyrene, polymerization initiators and crosslinkers were mixed with the styrene to form the penetrating surface modifier. Several types of polystyrene injection molding beads were used for the solid polystyrene in trials, and all worked well. A tracer dye was added to the mixture so penetration depth could be easily seen. After mixing, useful life of the mix was about 3 weeks at 10° C. Preparation was as follows:
1. 25% by weight (based on monomer weight) of polystyrene injection molding beads were dissolved in styrene monomer. Dissolution time was approximately 90 minutes with moderate mixing turbulence in the temperature range of 35 to 40° C. The mixture was cooled to about 20° C. Many types of styrene injection molding beads that are soluble in the styrene monomer can be used, including those modified with nylon and rubber. Styrene extenders alone can be used. Many different types of vinyl polymer beads or flakes can also be used. The key is that they must be soluble in styrene.
2. From about 0.3% to about 1% by weight of Dupont Vazo-67™ (AIBN) polymerization initiator (based on the total weight of styrene monomer plus dissolved polymer) was then added. Dupont Vazo 88™ and various peroxide initiatiors may also be used
3. Between 1% and 3% by weight of the cross-linking monomer di-vinyl benzene (concentration type 80) was added. Alternately, ethylene glycol dimethacrylate and other difunctional and trifunctional vinyl monomers can be used.

In step 1 above the styrene could be present in a range from about 10% to about 30% by weight, based on monomer weight, of polystyrene injection molding beads.

The present invention will be illustrated with the following examples. The following examples are provided to illustrate the embodiments of the present invention. They are not intended to limit the scope of this disclosure to the embodiments exemplified therein.

### EXAMPLES

### Furfuryl Alcohol-Lignin

The furfuryl alcohol-lignin mixture was applied on southern yellow pine oriented strand board (OSB) in several ways to illustrate some of the control and properties variability possible. Variations tried were:
1. The mix was applied with a roller onto an OSB surface. The coated surface was covered with a Teflon™ sheet and hot pressed at 145° C. (light contact only). Complete cure was achieved in about 3 minutes. Depth of polymer penetration in the OSB tried was shallow (between 0.1 and 0.5 mm). Penetration could be increased by using lower molecular weight (and thus less viscous) lignin.
2. The mix was spread as in step 1 above but Kraft paper was placed on top. Pressing as in step 1 formed a smooth outer surface layer, saturated with the polymer and bonded to the wood.
3. The mix was spread and hot pressed as above with the inclusion of burlap cloth that had been pre-saturated with the FA-lignin resin. This formed a rough-textured outer surface layer, saturated with the polymer and bonded to the wood.

### Styrene-Polystyrene

The styrene monomer/polymer mix as described above was applied on southern yellow pine OSB in a heavy coat using a brush. It was then hot pressed at between 130 and 145° C. using slight pressure for 3 minutes. The polymerization reaction was completed in 2 to 3 minutes. Penetration depth was 0.1 to 1 mm, depending on the permeability of the surface.

The penetration depth can be controlled by changing the initiator concentration, the amount of polystyrene in the mix and the curing time and temperature. Smooth or textured heated platens can be used to control surface texture.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

What is claimed is:

1. A method of melt-polymerization surface zone reinforcement and hardening of wood, wood products and other porous materials, comprising the steps of:
a) mixing liquid furfuryl alcohol with solid maleic anhydride wherein said maleic anhydride dissolves in said furfuryl alcohol;
b) adding lignin to the mixture of furfuryl alcohol with maleic anhydride to give a furfuryl alcohol-lignin mixture; and
c) applying the furfuryl alcohol-lignin mixture to a surface of a porous material wherein some of the furfuryl alcohol-lignin mixture is absorbed into the surface, and curing said furfuryl alcohol-lignin mixture.

2. The method according to claim 1 wherein step a) includes adding maleic anhydride in a range from about 10% to about 30% by weight of maleic anhydride to the furfuryl alcohol at a temperature in a range from about 20° C. to about 40° C., and wherein step b) includes, after the maleic anhydride has dissolved, adding the lignin in a range from about 20% to about 200% based on weight of furfuryl alcohol.

3. The method according to claim 1 wherein step a) includes adding about 20% by weight of maleic anhydride to the furfuryl alcohol at a temperature of about 20° C., and wherein step b) includes, after the maleic anhydride has dissolved, adding the lignin at about 50% based on weight of furfuryl alcohol.

4. The method according to claim 1 wherein said maleic anhydride in a solid form is granular or briquette maleic anhydride.

5. The method according to claim 1 wherein said lignins are is organosolv lignin, lignosulfonates, lignosulfonic acids and kraft lignins.

6. The method according to claim 1 including varying a concentration of said lignin and/or using lignin with a pre-selected molecular weight to give a desired viscosity to the lignin mixture.

7. The method according to claim 1 including repeating step c) a pre-selected number of times to build up a pre-selected amount of polymer in the penetrated zone.

8. The method according to claim 1 carried out in a continuously moving production line or in batches.

9. The method according to claim 1 carried out in batches.

10. The method according to claim 1 wherein said porous material is wood or a wood product including those made from veneer, fibers, strands, particles or other comminuted wood.

11. A method of melt-polymerization surface reinforcement and hardening of wood, wood products and other porous materials, comprising the steps of:
a) dissolving solid polystyrene in styrene monomer to form a first solution;
b) adding a polymerization initiator and adding a cross-linking agent to the first solution to form a second solution; and
c) applying said second solution to a surface of a porous material and curing the second solution after absorption into the surface.

12. The method according to claim 11 wherein said step a) includes dissolving about 10% to 30% by weight, based on monomer weight, of polystyrene injection molding beads in the styrene monomer in a temperature range from about 35 to about 40° C., thereafter cooling said first solution to a temperature of about 20° C., and wherein step b) includes adding about 1% by weight of Dupont Vazo-67™ (AIBN) polymerization initiator, based on the total weight of styrene monomer plus dissolved polymer, and including adding about 3% by weight of the cross-linking monomer di-vinyl benzene (concentration type 80).

13. The method according to claim 11 including adding a dye to said solution to allow penetration depth of the mixture into the porous material to be monitored or to color the product.

14. The method according to claim 11 including repeating step c) a pre-selected number of times to build up a pre-selected amount of polymer in the penetrated zone
